(19) United States
(12) Patent Application Publication
(10) Pub. No.: US 2002/0027700 A1
(43) Pub. Date: Mar. 7, 2002

(54) Electrochromic display device having high edge sharpness

(76) Inventors: Horst Berneth, Leverkusen (DE); Serguei Kostromine, Swisttal (DE); Ralf Neigl, Tarrytown, NY (US)

Correspondence Address: BAYER CORPORATION, PATENT DEPARTMENT, 100 BAYER ROAD, PITTSBURGH, PA, 15205, US

(21) Appl. No.: 09/853,163

(22) Filed: May 10, 2001

(30) Foreign Application Priority Data
May 15, 2000 (DE) 10023744.4

(51) Int. Cl. G02F 1/15

(52) U.S. Cl. 359/265; 428/76; 428/426

(57) ABSTRACT

An electrochromic device comprising a pair of glass or plastic plates or plastic films of which at least one plate or film, preferably both plates or films, are provided on in each case one side with an electrically conductive coating, of which at least one plate or film and its conductive coating are transparent, of which the other may be mirrored, and of which in the case of at least one of the two plates or films the electrically conductive layer can be divided into separate, individually contacted area segments, in which the plates or films are joined together via a sealing ring on the sides of their conductive coating, and the volume formed by the two plates or films and the sealing ring is filled with an electrochromic medium, wherein the electrochromic medium comprises a pair of electrochromic substances OX₂ⁿ⁺ and RED₁^{m-}, in which n and m, independently of one another, are integers from 2 to 4. solves the problem of unsharp imaging by diffusion.

### BACKGROUND

The present invention relates to an electrochromic device, and to electrochromic substances.

Electrochromic devices are already known, for example from D. Theis in Ullmann's Encyclopaedia of Industrial Chemistry, Vol. A 81 p. 622, Verlag Chemie 1987 and WO-A 94/23333. A distinction is made between two basic types: (i) Type 1: full-area electrochromic devices, and (ii) Type 2: electrochromic devices having structured electrodes.

Type 1 is used, for example, in electrically darkenable window panes or electrically dimmable automobile mirrors. Such devices are disclosed, for example, in U.S. Pat. No. 4,902,108.

Type 2 is used in segment and matrix displays. Such display devices are proposed, for example, in DE-A 196 31 728. Devices of this type can be observed transmissively or, in the case of reflection, reflectively.

WO-A 94/23333 compares electrochromic materials having different constructions, but these are not used as display devices:

Construction a: the electrochromic substances are in the form of a fixed film or layer on the electrodes (Ullmann, see above).

Construction b: the electrochromic substances are deposited on the electrodes as a layer by the redox process (Ullmann, see above).

Construction c: the electrochromic substances remain permanently in solution.

For construction a), the best-known electrochromic material is the tungsten oxide/palladium hydride pair.

For construction b), viologens have been described as electrochromic substances. These devices are not self-erasing, i.e., the image produced remains after the current has been switched off and can only be erased again by reversing the voltage. Such devices are not particularly stable and do not allow a large number of switching cycles.

In addition, such cells constructed using tungsten oxide/palladium hydride in particular cannot be operated in transmitted light, but only reflectively, owing to light scattering at these electrochromic layers.

Elektrokhimiya 13, 32-37 (1977), 13, 404-408,14, 319-322 (1978), U.S. Pat. No. 4,902,108 and U.S. Pat. No. 5,140,455 disclose an electrochromic system of the latter construction c). An electrochromic cell which is constructed from glass plates with a conductive coating comprises a solution of a pair of electrochromic substances in an inert solvent.

The pair of electrochromic substances used is one electrochemically reversibly reducible substance and one reversibly oxidizable substance. Both substances are colorless or only weakly colored in the ground state. Under the action of an electric voltage, one substance is reduced and the other oxidized, both becoming colored. When the voltage is switched off, the ground state re-forms in the case of both substances, resulting in disappearance or fading of the color.

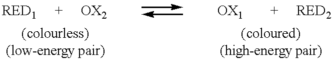

U.S. Pat. No. 4,902,108 discloses that suitable pairs of redox substances are those in which the reducible substance has at least two chemically reversible reduction waves in the cyclic voltammogram and the oxidizable substance correspondingly has at least two chemically reversible oxidation waves.

According to WO-A 94/23333, however, such solution systems of construction c have serious disadvantages.

Diffusion of the electrochromic substances in the solution causes fuzzy color boundaries and high power consumption in order to maintain the colored state, since the colored substances are permanently degraded by recombination and reaction at the opposite electrode in each case.

Nevertheless, various applications have been described for such electrochromic cells of construction c). For example, they can be formed as automobile rear-view mirrors which can be darkened during night driving by application of a voltage and thus prevent dazzling by the headlamps of following vehicles (U.S. Pat. No. 3,280,701, U.S. Pat. No. 4,902,108 and EP-A 0 435 689). Furthermore, such cells can also be employed in window panes or automobile sunroofs, in which they darken the sunlight after application of a voltage. Likewise described is the use of such devices as electrochromic display devices, for example in segment or matrix displays having structured electrodes (DE-A 196 31 728).

The electrochromic cells normally consist of a pair of glass plates, of which, in the case of the automobile mirror, one is mirrored. One side of these plates is coated over its surface with a light-transparent, electroconductive layer, for example indium-tin oxide (ITO), and in the case of display devices this conductive coating is divided into electrically separated segments provided with individual contacts. These plates are used to construct a cell by joining them by means of a sealing ring with their electroconductively coated sides facing one another to form a cell. This cell is filled with an electrochromic liquid via an opening, and the cell is tightly sealed. The two plates are connected to a voltage source via the ITO layers.

A problem with electrochromic display devices in particular is unsharp imaging by diffusion, in particular lateral diffusion of the colored forms of the electrochromic substances formed at the electrodes. Also associated with this phenomenon is a problem with self-erasing of the device after the current is switched off in accordance with the above-described scheme.

There was therefore a need for an electrochromic medium and the electrochromic substances present therein which prevents such diffusion, in particular lateral diffusion, without preventing vertical diffusion.

It has now been found that this problem is solved by an electrochromic medium comprises a pair of electrochromic substances OX₂ⁿ⁺ and RED₁^{m-}, in which n and m, independently of one another, are integers from 2 to 4. In particular, n and m are taken to mean 2.

### SUMMARY

The invention relates to an electrochromic device comprising: a pair of glass or plastic plates or plastic films, wherein (i) at least one plate or film has one side with an electrically conductive coating, (ii) at least one plate or film and its conductive coating is transparent, (iii) a plate a film that is optionally mirrored, and (iv) at least one plate or film has an electrically conductive layer that is optionally divisible into separate, individually contacted area segments, (b) a sealing ring that joins the plates or films together on the side of the conductive coating, and (c) an electrochromic medium that fills volume formed by the a pair of glass or plastic plates or plastic films, wherein the electrochromic medium comprises a pair of electrochromic substances OX₂ⁿ⁺ and RED₁^{m-}, in which n and m, independently of one another, are integers from 2 to 4.

### DESCRIPTION OF THE FIGURES

These and other features, aspects, and advantages of the present invention will become better understood with reference to the following description and appended claims, where

FIG. 1 is a device in accordance with the invention.

### DESCRIPTION

The invention relates to an electrochromic device comprising (a) a pair of glass or plastic plates or plastic films, wherein (i) at least one plate or film, has one side with an electrically conductive coating, (ii) at least one plate or film and its conductive coating is transparent and the other plate or film is optionally mirrored, and (iii) at least one plate or film has an electrically conductive layer that can be divisible into separate, individually contacted area segments, (b) a sealing ring that joins the plates or films together on the side of the conductive coating, (c) an electrochromic medium that fills the volume formed by the two plates or films and the sealing ring, wherein the electrochromic medium comprises a pair of electrochromic substances OX₂ⁿ⁺ and RED₁^{m-}, in which n and m, independently of one another, are integers from 2 to 4. In a preferred embodiment of the invention, n and m are 2. In another preferred embodiment of the invention, in the case of at least one of the two plates or films the electrically conductive layer is divided into separate, individually contacted area segments.

In general, the reducible substance OX₂ⁿ⁺ is taken to mean a substance which has at least one, preferably at least two, chemically reversible reduction waves in the cyclic voltammogram, and the oxidizable substance RED₁^{m-} is correspondingly taken to mean a substance which has at least one, preferably at least two, chemically reversible oxidation waves.

These reduction or oxidation processes, in particular the one-electron reduction or oxidation, are usually associated with a change in the absorption of the electrochromic substances in the visible part of the spectrum. Such a change in absorption is required for at least one of the two electrochromic substances OX₂ⁿ⁺ or RED₁^{m-}. For example, OX₂⁺ or RED₁^{m-} may be colorless or weakly colored and become colored by reduction or oxidation or vice versa. Alternatively, the color can change, for example from red to blue.

The product which is formed at the cathode by one-electron reduction of OX₂ⁿ⁺ and which is possibly colored has the charge (n−1)+, the product which is formed at the anode by one-electron oxidation of RED₁^{m-} and which is possibly colored has the charge (m−1)−. This means that the level of the charge is changed on oxidation or reduction, but not the sign of the charge.

Electrochromic substances of the type OX₂ⁿ⁺ are known in many structural variations, for example from the literature cited above. Suitable OX₂ⁿ⁺ for the purposes of the invention are

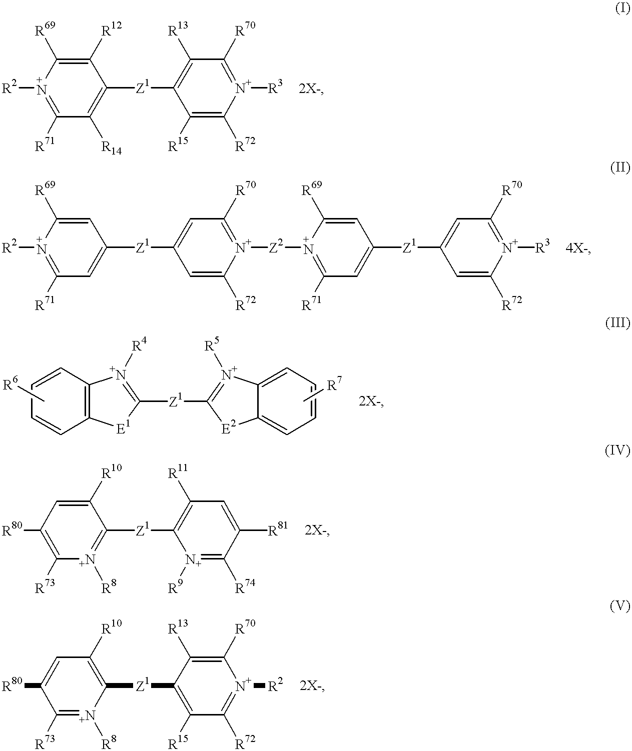

in which

R² to R⁵, R³ and R⁹, independently of one another, are C₁- to C₁₈-alkyl, C₂- to C₁₂-alkenyl, C₄- to C₇-cycloalkyl, C₇- to C₁₅-aralkyl or C₆- to C₁₀-aryl, or

R⁴; R⁵ or R⁸; R⁹ together can form a —(CH₂)₂— or —(CH₂)₃— bridge,

R⁶ and R⁷, independently of one another, are hydrogen, C₁- to C₄-alkyl, C₁- to C₄-alkoxy, halogen, cyano, nitro or C₁- to C₄-alkoxycarbonyl, or

R¹⁰; R¹¹, R¹⁰; R¹³, R¹²; R¹³ and R¹⁴; R¹⁵, independently of one another, are hydrogen or in pairs are a —(CH₂)₂—, —(CH₂)₃— or —CH═CH— bridge,

R⁶⁹ to R⁷⁴, R⁸⁰ and R⁸¹, independently of one another, are hydrogen or C₁- to C₆-alkyl, and

R⁶⁹ to R⁷⁴, independently of one another, are additionally aryl, or

R⁶⁹; R¹², R⁷⁰; R¹³, R⁷³; R⁸⁰ and/or R⁷⁴; R⁸¹ together form a —CH═CH— CH═CH— bridge,

E¹ and E² independently of one another, are O, S, NR¹ or C(CH₃)₂, or

E¹ and E² together form an —N—(CH₂)₂—N— bridge,

R¹ is C₁- to C₁₈-alkyl, C₂- to C₁₂-alkenyl, C₄- to C₇-cycloalkyl, C₇- to C₁₅-aralkyl or C₆- to C₁₀-aryl,

Z¹ is a direct bond, —CH═CH—, —C(CH₃)═CH—, —C(CN)═CH—, —CCl═CCl—, —C(OH)═CH—, —CCl═CH—, —C—C—, —CH═N—N═CH—, —C(CH₃)═N—N═C(CH₃)—, —CCl═N—N═CCl— or —C₆H₄—,

Z² is —(CH₂)ᵣ— or —CH₂—C₆H₄—CH₂—,

r is an integer from 1 to 10, and

X⁻ is an anion which is redox-inert under the conditions.

Preferred examples are the viologens of the formulae

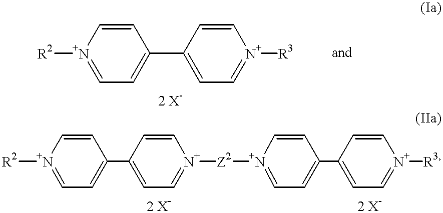

in which

R² and R³ are C₁- to C₁₂-alkyl, C₇- to C₁₂-aralkyl or C₆- to C₁₀-aryl,

Z² is —(CH₂)₃—, —(CH₂)₄—, —(CH₂)₅— or —CH₂—C₆H₄—CH₂—, and

X⁻ is an anion.

Particularly preferably, R² and R³ are methyl, ethyl, propyl, butyl, heptyl, 2-ethyl-hexyl, benzyl, phenylethyl or phenylpropyl, and

Z² is —(CH₂)₃—, —(CH₂)₄— or o-(—CH₂—C₆H₄—CH₂—).

X⁻ can also be one equivalent of RED₁^{m-}. Only a few electrochromic substances of the type RED₁^{m-} are known, e.g., those of the formula

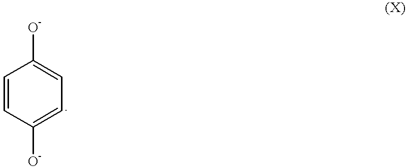

RED₁^{m-} which are advantageous over electrochromic substances of the formula (X) are those of the general formula

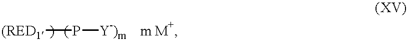

in which

RED_{1′} is the m-valent radical of a reversibly oxidizable electrochromic compound,

P is a bridge,

Y⁻ is an anionic group,

M⁺ is a cation, and

m is an integer from 2 to 4, preferably 2.

Suitable RED_{1′} are known, for example, from DE-A 196 31 728:

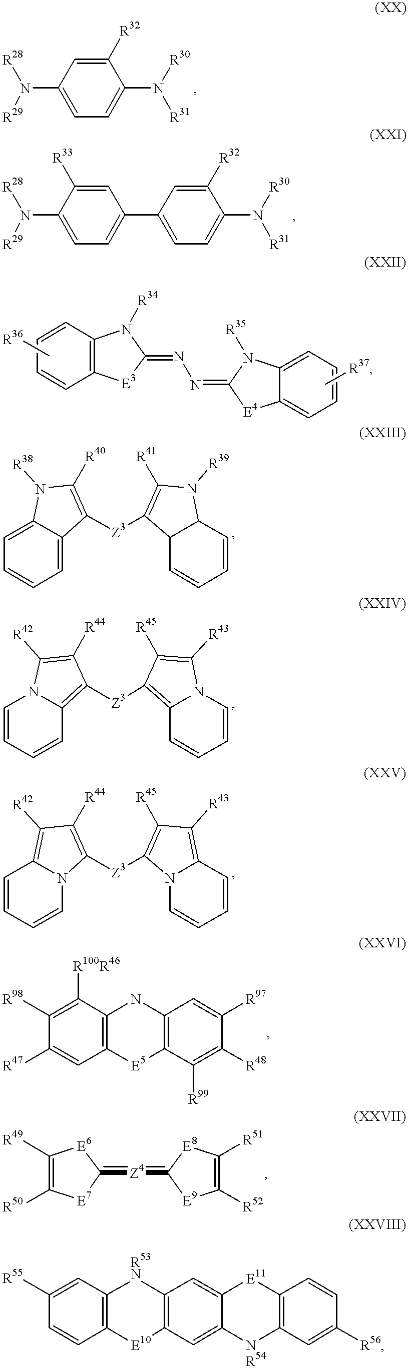

in which

R²⁸ to R³¹, R³⁴, R³⁵, R³⁸, R³⁹, R⁵³ and R⁵⁴, independently of one another, are C₁- to C₁₈-alkyl, C₂- to C₁₂-alkenyl, C₄- to C₇-cycloalkyl, C₇- to C₁₅-aralkyl or C₆- to C₁₀-aryl,

R³², R³³, R³⁶, R³⁷, R⁴⁰, R⁴¹, R⁴² to R⁴⁵, R⁴⁷, R⁴⁸, R⁴⁹ to R⁵², R⁵⁵ to R⁵⁸ and R⁹⁷ to R¹⁰⁰, independently of one another, are hydrogen, C₁- to C₄-alkyl, C₁- to C₄-alkoxy, halogen, cyano, nitro, C₁- to C₄-alkoxycarbonyl, C₆- to C₁₀-aryl or C₆- to C₁₀-aryloxy, and

R⁵⁷ and R⁵⁸ are additionally an aromatic or quasi-aromatic, five- or six-membered heterocyclic ring which is optionally benzo-fused, and R⁴⁸ is additionally NR⁷⁵R⁷⁶, or

R⁴⁹; R⁵⁰, R⁵¹; R⁵² and/or R⁴⁸; R⁹⁷ or R⁴⁸; R⁹⁹, R⁹⁷; R⁹⁸ or R⁹⁸; R¹⁰⁰, independently of one another, form a —(CH₂)₃—, —(CH₂)₄—, —(CH₂)₅— or —CH═CH—CH═CH— bridge,

Z³ is a direct bond, a —CH═CH— or —N═N— bridge,

Z⁴ is a direct double bond, a ═CH—CH═ or ═N—N═ bridge,

E³ to E⁵, E¹⁰ and E¹¹, independently of one another, are O, S, NR⁵⁹ or C(CH₃)₂, and

E⁵ is additionally C═O or SO₂,

E³ and E⁴, independently of one another, can additionally be —CH═CH—,

E⁶ to E⁹, independently of one another, are S, Se or NR⁵⁹,

R⁵⁹, R⁷⁵ and R⁷⁶, independently of one another, are C₁- to C₁₂-alkyl, C₂- to C₈-alkenyl, C₄- to C₇-cycloalkyl, C₇- to C₁₅-aralkyl, C₆- to C₁₀-aryl, and

R⁷⁵ is additionally hydrogen or R⁷⁵ and R⁷⁶ in the definition of NR⁷⁵R⁷⁶ are, together with the N atom to which they are attached, a five- or six-membered ring, which optionally contains further heteroatoms,

R⁶¹ to R⁶⁸, independently of one another, are hydrogen, C₁- to C₆-alkyl, C₁- to C₄-alkoxy, cyano, C₁- to C₄-alkoxycarbonyl or C₆- to C₁₀-aryl, and

R⁶¹; R⁶² and R⁶⁷; R⁶⁸, independently of one another, additionally form a —(CH₂)₃—₁—(CH₂)₄— or —CH═CH—CH═CH— bridge, or

R⁶²; R⁶³, R⁶⁴; R⁶⁵ and R⁶⁶; R⁶⁷ form an —O—CH₂CH₂—O— or —O—CH₂CH₂CH₂—O— bridge,

v is an integer between 0 and 100,

R⁸², R⁸³, R⁸⁸ and R⁸⁹, independently of one another, are C₁- to C₁₈-alkyl, C₂- to C₁₂-alkenyl, C₄- to C₇-cycloalkyl, C₇- to C₁₅-aralkyl or C₆- to C₁₀-aryl,

R⁸⁴ to R⁸⁷ and R⁹⁰ to R⁹³, independently of one another, are hydrogen or C₁- to C₆-alkyl, or

R⁸⁴; R⁸⁶, R⁸⁵; R⁸⁷, R⁹⁰; R⁹² and/or R⁹¹; R⁹³ together form a —CH═CH—CH═CH— bridge.

Another suitable RED_{1′} is ferrocene.

Any of the radicals listed in these formulae can additionally be a bond to P, in which m (is 2 to 4, preferably 2) of these radicals have this meaning.

P is preferably a direct bond, —(CH₂)ₚ—, (CH₂)_{q}—O—(CH₂)ₛ—, —(CH₂)_{q}—C₆H₄—(CH₂)ₛ— or —C₆H₄—, in which p, q and s, independently of one another, are integers from 1 to 12, and q or s can also be 0.

Y⁻ is preferably SO₃⁻, OSO₃⁻, COO⁻, PO₃⁻, OPO₂⁻ or a radical of the formula

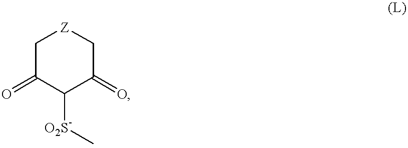

or a mesomeric form thereof, in which

Z is a bridge, for example —O—C(R¹⁰¹R¹⁰²)—O—, —N(R¹⁰³)—CO—N(R¹⁰⁴)—, —N(R¹⁰³)—SO₂—N(R¹⁰⁴)—,

in which

R¹⁰¹ to R¹⁰⁴, independently of one another, are alkyl or aryl.

Y⁻ is particularly preferably SO₃.

M⁺ is preferably an ion of an alkali metal, for example Li⁺, Na⁺, K⁺, an ammonium ion, for example tetramethylammonium, tetraethylammonium, tetrabutylammonium, methyl-tricapryoammonium, benzyltriethylammonium or one equivalent of OX₂^{m+}.

Particularly preferred RED₁^{m-} are

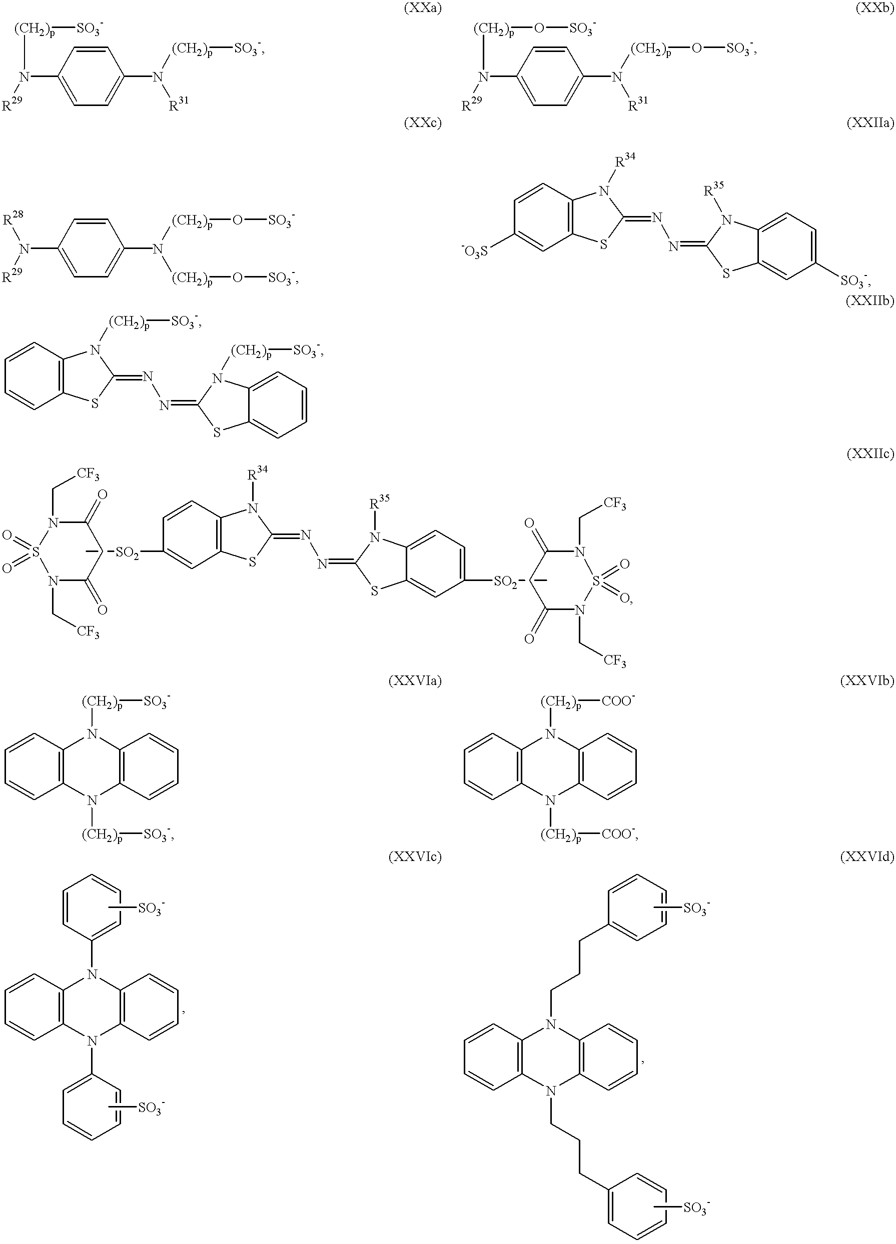

in which

p, R²⁸, R²⁹, R³¹, R³⁴ and R³⁵ are as defined above.

Suitable electrochromic compounds for the purposes of the invention are likewise those of the formula

OX₂ⁿ⁺ RED₁^{m-} (C),

in which m and n are identical, preferably 2 in each case, and

OX₂ⁿ⁺ and RED₁^{m-} are as defined above in general, preferred or particularly preferred terms.

Particular preference is given to electrochromic compounds of the formula

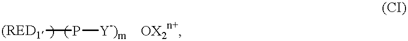

in which RED_{1′}, P, Y⁻ and OX₂ⁿ⁺ are as defined as above, and m and n are 2.

An example is

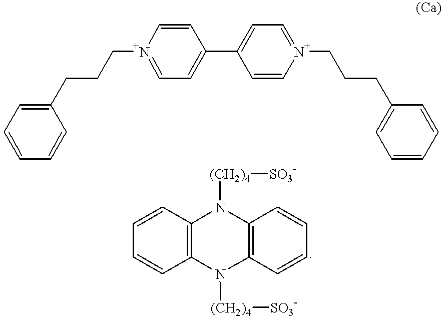

The invention furthermore provides electrochromic compounds RED₁ of the formula

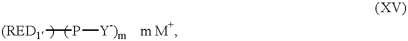

in which RED_{1′}, P, Y⁻, m and M⁺ are as defined above in general, preferred or particularly preferred terms.

Some electrochromic compounds of the formula (XV) are already known, e.g., (XXIIa) and (XXIIc) with R³⁴ and R³⁵ is ethyl, and (XXXIV) (WO 98/29396).

The invention furthermore provides electrochromic compounds of the formula

OX₂ⁿ⁺ RED₁⁻m (C),

in which m and n are identical, preferably 2 in each case, and

OX₂ⁿ⁺ and RED₁^{m-} are as defined above in general, preferred or particularly preferred terms.

The invention furthermore provides a process for the preparation of the electrochromic compounds according to the invention of the formula (XV), in which RED_{1′} is a bivalent radical of the formulae (XX), (XXI), (XXIII), (XXVI) and (XXVIII), in which R²⁸, R³⁰, R³⁸, R³⁹, R⁴⁶, R⁵⁹, R⁵³ and R⁵⁴ are a direct bond to P, wherein the compounds of the formulae (XX), (XXI), (XXIII), (XXVI) and (XXVIII), in which R²⁸, R³⁰, R³⁸, R³⁹, R⁴⁶, R⁵⁹, R⁵³ and R⁵⁴ are hydrogen, are reacted with an alkylating agent F—P—Y⁻ in the presence of a base, in which

F is a leaving group, and

P and Y⁻ are as defined above.

F is, for example, Cl, Br, I, OSO₂CH₃.

Examples are chloroacetic acid, 3-bromopropionic acid, 2-chloroethanesulfonic acid, 4-chlorobutanesulfonic acid, 4-chloromethylbenzenesulfonic acid.

Alkylating agents that may be used are in particular those in which F and Y are a functional unit, but ultimately lead to formation of a —P—Y⁻ substituent. Examples are cyclic sulfonic esters such as propanesulton and butanesulton.

Suitable bases include alkali metal and alkaline earth metal hydroxides, oxides, carbonates or alkoxides, for example sodium hydroxide, potassium hydroxide, magnesium oxide, sodium carbonate, sodium hydrogencarbonate, sodium methoxide, and potassium tert-butoxide.

Suitable solvents are all solvents which do not react with the alkylating agent. Examples are toluene, chlorobenzene, dimethylformamide, N-methylpyrrolidone, acetonitrile, dioxane, tetrahydrofuran, sulfolane, ethyl acetate. If desired, water or alcohols can be added, for example to improve the solubility.

It is also possible to add phase transfer catalysts, if desired, for example tetrabutylammonium bromide, trimethylbenzylammonium chloride, methyl-tricaprylammonium chloride.

It is also possible to add iodide ions, if desired, for example in the form of potassium iodide or tetrabutylammonium iodide.

The reaction is carried out at from room temperature to the boiling point of the medium, preferably at 40 to 120° C.

In certain cases, e.g., those of the formula (XXVI) with R⁴⁶ and R⁵⁹ is hydrogen, the starting materials are not directly obtainable, or only directly obtainable with difficulty. In these cases it is advantageous to synthesize these materials immediately prior to or during alkylation. In the case of (XXVI), corresponding phenazines are used as starting materials and these are reduced during alkylation with suitable reducing agents, for example sodium dithionite. Alternatively, the phenazines can be reduced directly to form the alkylatable anions (for (XXVI) R⁴⁶ and R⁵⁹ is negative charge) followed by reaction with the alkylating agent of the formula F—P—Y⁻. Such a reduction can be carried out for example using alkali metals or alkaline earth metals or amalgams thereof, for example sodium, sodium/potassium or sodium amalgam. Suitable solvents for this case include ethers such as tetrahydrofuran, dioxane, ethylene glycol dimethyl ether, ethylene glycol diethyl ether.

The electrochromic device according to the invention preferably contains, in its electrochromic medium, at least one solvent in which the electrochromic substances, if used a conductive salt and if used further additives, are dissolved. The solvent may also be thickened in the form of a gel, for example by polyelectrolytes, porous solids or nanoparticles having large active surface areas.

Suitable solvents are all solvents which are redox-inert under the selected voltages and which cannot eliminate electrophiles or nucleophiles or themselves react as sufficiently strong electrophiles or nucleophiles and thus could react with the colored free-radical ions. Examples are propylene carbonate, γ-butyrolactone, acetonitrile, propionitrile, glutaronitrile, methylglutaronitrile, 3,3′-oxydipropionitrile, hydroxypropionitrile, benzoritrile, dimethylformamide, N-methylpyrrolidone, sulfolane, 3-methylsulfolane or mixtures thereof. Preference is given to propylene carbonate and mixtures thereof with glutaronitrile or 3-methylsulfolane.

The electrochromic solution can contain at least one inert conductive salt. Suitable inert conductive salts are lithium, sodium and tetraalkylammonium salts, in particular the latter. The alkyl groups can contain between 1 and 18 carbon atoms and can be identical or different. Preference is given to tetrabutylammonium. Suitable anions for these salts, in particular as anions X⁻ in the formulae (I) to (V), are all redox-inert, colorless anions.

Examples are tetrafluoroborate, tetraphenylborate, cyanotriphenylborate, tetramethoxyborate, tetrapropoxyborate, tetraphenoxyborate, perchlorate, chloride, nitrate, sulfate, phosphate, methanesulfonate, ethanesulfonate, tetradecanesulfonate, pentadecanesulfonate, trifluoromethanesulfonate, perfluorobutanesulfonate, perfluorooctanesulfonate, benzenesulfonate, chlorobenzenesulfonate, toluenesulfonate, butylbenzenesulfonate, tert-butylbenzenesulfonate, dodecylbenzenesulfonate, trifluoromethylbenzenesulfonate, hexafluorophosphate, hexafluoroarsenate, hexafluorosilicate, 7,8- or 7,9-dicarbanido-undecaborate(-1) or (−2), which are optionally substituted on the B and/or C atoms by one or two methyl, ethyl, butyl or phenyl groups, dodecahydro-dicarbadodecaborate (−2) or B-methyl-C-phenyl-dodecahydro-dicarbadodecaborate(−1). The conductive salt may also form from the counteranions of OX₂²⁺ and RED₁ⁿ⁻. The conductive salts are preferably employed in the range from 0 to 1 mol/l.

Further additives which can be employed are thickeners in order to control the viscosity of the electro-active solution, This can be of importance for avoiding segregation, i.e., the formation of colored streaks or spots on extended operation of the electrochromic device in the switched-on state, and for controlling the fading rate after the current is switched off.

Suitable thickeners are all compounds customary for this purpose, such as, for example, polyacrylate, polymethacrylate (Luctite L®), polycarbonate or polyurethane.

Suitable further additives for the electrochromic solution for the occasionally desired protection against UV light (<350 nm) are UV absorbers. Examples are UVINUL® 3000 (2,4-dihydroxybenzophenone, BASF), SANDUVOR® 3035 (2-hydroxy-4-n-octyloxybenzophenone, Clariant), Tinuvin® 571 (2-(2H-benzotriazol-2-yl)-6-dodecyl-4-methylphenol, Ciba), Cyasorb 24™ (2,2′-dihydroxy-4-methoxybenzophenone, American Cyanamid Company), UVINUL® 3035 (ethyl 2-cyano-3,3-diphenylacrylate, BASF), UVINUL® 3039 (2-ethylhexyl 2-cyano-3,3-diphenylacrylate, BASF), UVINUL® 3088 (2-ethylhexyl p-methoxycinnamate, BASF), CHIMASSORB® 90 (2-hydroxy-4-methoxybenzophenone, Ciba), propyl 3,3-dimethyl-5,6-dimethoxyindan-1-ylidene-cyanoacetate.

Preference is given to the five last-mentioned compounds. Preference is likewise given to mixtures of UV absorbers, for example of the four last-mentioned compounds. Particular preference is given to the mixture of UVINUL® 3039 (BASF) and CHIMASSORB® 90 and propyl 3,3-dimethyl-5,6-dimethoxyindan-1-ylidene-cyanoacetate.

The UV absorbers are employed in the range from 0.01 to 2 mol/l, preferably from 0.04 to 1 mol/l. The UV absorbers can also be present in the plates or films of the electrochromic device or in a coating of these plates or films. In these use forms, inorganic nanoparticles are also very useful as UV absorbers. In addition, other light stabilizer materials may be used, such as quenchers or free radical scavengers as are customary in the polymer field, e.g., UVINUL® 4049H (BASF), UVINUL® 4050H (BASF).

The electrochromic solution contains each of the electrochromic substances OX₂ⁿ⁺ and RED₁^{m-}, in particular those of the formulae (I), (II) and (XV) in which RED_{1′} is a radical of the formulae (XX), (XXII) and (XXVI), in a concentration of at least 104 mol/l, preferably 0.001 to 0.5 mol/l. The total concentration of all electrochromic substances present is preferably less than 1 mol/l.

In order to operate the electrochromic device according to the invention, a constant, pulsed or amplitude-varying, for example sinusoidal, direct current is used. The voltage depends on the desired color depth, but in particular on the reduction or oxidation potentials of the OX₂ⁿ⁺ and RED₁^{m-} used. Such potentials can be found, for example, in Topics in Current Chemistry, Volume 92, pp. 1-44, (1980) or Angew. Chem. 90, 927 (1978) or in the references cited therein. The difference in their potentials is a guide for the requisite voltage, but the electrochromic device can be operated at lower or higher voltage. In many cases, for example when using OX₂ⁿ⁺ is formula (Ia) and RED₁^{m-} is formula (XXVIa), this potential difference necessary for operation is ≦1 V. Such electrochromic devices can therefore be supplied in a simple manner with the current from photovoltaic silicon cells.

When the voltage is switched off, the electrochromic device according to the invention returns to its original state. This erasing can be considerably accelerated if the contacted segments or plates are short-circuited. The display can also be erased very rapidly by repeated reversal of the voltage, optionally also with simultaneous reduction in the voltage.

By varying the layer thickness of the electrochromic device, the viscosity of the electrochromic solution and/or the diffusibility or driftability of the electrochromic substances, the switch-on and switch-off times of the display device can be modified within broad limits. Thus, for example, thin layers exhibit shorter switching times than thick layers. It is thus possible to construct fast- and slow-switchable devices and thus to match them to the particular applications in an optimum manner.

In slow devices, in particular display devices, a power-saving or refresh mode can be used in the switched-on state in order to maintain the displayed information. After the information to be displayed has been built up, for example by direct voltage of sufficient level which is constant or varying with high frequency or pulsed, the voltage is switched to pulsed or varying direct voltage of low frequency, with the contacting of the segments not being short-circuited during the phases in which the voltage is zero. This low frequency can be, for example, in the region of 1 Hz or lower, while the durations of the switch-on and switch-off phases need not be of equal lengths, but instead, for example, the switch-off phases can be significantly longer. Since the color depth of the displayed information only drops slowly during the current pauses in the non-short-circuited state, relatively short current pulses are sufficient to compensate for these losses again in the subsequent refresh phase. In this way, a flicker-free image with virtually constant color depth is obtained, but its maintenance requires only a fraction of the current that would arise in the case of permanent current flow.

The display devices according to the invention have the following advantages over electrochromic display devices described in the above-cited prior art:

1. The segments to which a voltage is applied equally exhibit a sharp-edged color boundary, both for the colored compounds formed at the cathode and for those formed at the anode. In prior art devices, edge sharpness at the anode is usually poor.

2. Even after prolonged operation using direct voltage of constant polarity, the display device erases, after switching off the current and possibly short-circuiting the connections or short voltage pulses of opposite sign, just as rapidly as in the case of brief operation, and returns to the color state of the unswitched cell (e.g., colorless). In prior art devices, such an erasure in the case of brief operation likewise occurs rapidly and completely, but in the case of prolonged operation, only part of the color is erased in a short period of time. In this case, erasing the residual color takes a relatively long time, since the colored compounds formed at the anode in particular have diffused way beyond the boundaries of the switched segments.

Specific embodiments of the above-mentioned types 1 and 2 can be, for example, the following, which are likewise provided by the invention if they comprise a pair of electrochromic substances according to the invention.

Type 1: (non-mirrored) from the light protection/light filter area: window panes for, for example, buildings, road vehicles, aircraft, railways, ships, roof glazing, automobile sunroofs, glazing of greenhouses and conservatories, light filters of any desired type; from the security/confidentiality area: separating panes for, for example, room dividers in, for example, offices, road vehicles, aircraft, railways, sight protection screens, for example at bank counters, door glazing, visors for motorcycle or pilot helmets. Additional applications for Type 1 (non-mirrored) devices from the design area include the following applications: glazing of ovens, microwave equipment, other domestic appliances, furniture; from the display area analogue voltage displays, as battery testers, tank displays, and temperature displays.

Type 1: (mirrored)

Mirrors of all types for road vehicles, railways, in particular planar, spherical, aspherical mirrors and combinations thereof, such as spherical/aspherical mirror glazing in furniture.

Type 2:

Display devices of all types, segment or matrix displays for watches, computers, electrical equipment, electronic equipment, such as radios, amplifiers, TV sets, CD players, destination displays in buses and trains, departure displays in stations and airports, flat screens, all applications mentioned under types 1 and 2 which contain at least one switchable static or variable display device, such as separating screens containing displays such as “Please do not disturb,” “Counter closed,” for example automobile mirrors containing displays of any desired type, such as temperature display, display for faults in the vehicle (for example oil temperature, open doors) time, compass direction.

The invention is further described in the following illustrative examples in which all parts and percentages are by weight unless otherwise indicated.

### EXAMPLES

### Example 1

6.5 g of phenazine were dissolved in a mixture of 35 ml of acetonitrile and 1 ml of water under a nitrogen atmosphere. 9 ml of butanesultone, 7.7 g of anhydrous sodium carbonate, 7.2 g of sodium dithionite and 1.3 g of tetrabutylammonium bromide were added in succession. The mixture was stirred for 18 h at reflux temperature under a nitrogen atmosphere. The thick suspension was then diluted with 40 ml of water, admixed with a further 9 ml of butanesultone, 7.7 g of sodium carbonate and 7.2 g of sodium dithionite and stirred for a further 15 h at reflux temperature. The mixture was cooled and salts were filtered off. On standing overnight under a nitrogen atmosphere a brownish powder precipitated which was filtered off with suction. The powder was briefly boiled with 20 ml of toluene, cooled, again filtered off with suction, washed with toluene and dried. 5.4 g (30% of theory) of the phenazine of the formula

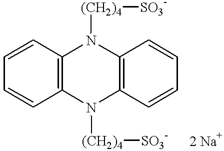

were obtained.

MS (ESI): m/e is 475 (M²⁻+Na⁺), 452 (M⁻), 226 (M²⁻) in which M²⁻ is dianion of the above formula.

### Example 2

Two ITO-coated glass plates (50×45 mm²) were provided on the ITO-coated side with a strip of adhesive tape (Tesapack 124 from Beiersdorf, Hamburg), which was about 7 mm in width, in the middle over the whole width of the plate. The glass plates prepared in this way were introduced into an aqueous bath containing 47.5% strength concentrated hydrochloric acid and 5% iron(III) chloride which had been heated to about 40° C. After 10 minutes, the glass plates were removed and rinsed with distilled water. The adhesive strip was removed. In this way, two glass plates (1) and (4) which carried only a 50×7 mm² ITO strip (2) and (5) were obtained.

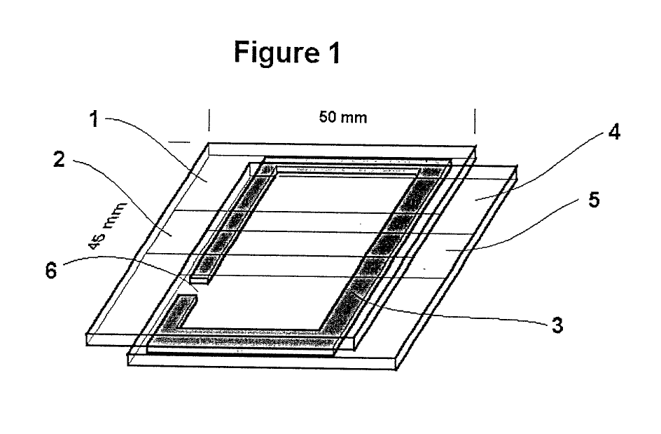

A mixture of 97% of photocuring epoxy adhesive DELO-Katiobond® 4594, DELO Industrieklebstoffe, Landsberg, and 3% of glass beads with a diameter of 100 μm was applied in the form of a ring (3) to the ITO-coated side of the glass plate (4), with an aperture (6) being left open. The glass plate (1) was then placed on the adhesive bead in such a way that the ITO layers of the two plates (1) and (4) were facing one another and the two ITO strips (2) and (5) were in congruence on top of one another. The adhesive was cured by exposure for 10 minutes to daylight in the vicinity of a window and subsequently for 20 minutes at 105° C. without exposure to light. In this way, a cell as shown in FIG. 1 was obtained.

The cell was then placed vertically, with the aperture (6) facing downward, in a dish under a nitrogen atmosphere, the dish containing a solution which was 0.02 molar with respect to the electrochromic compound of the formula

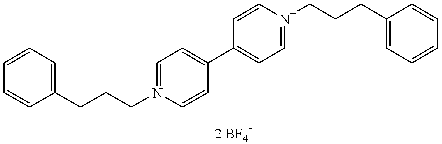

and 0.02 molar with respect to the electrochromic compound of the formula

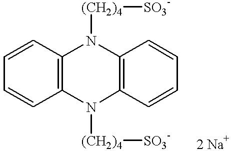

and finally 0.02 molar with respect to the UV absorber of the formula

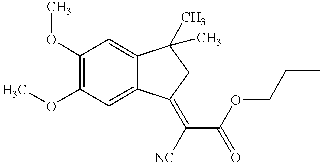

in anhydrous, oxygen-free N-methylpryrrolidone. The aperture (6) of the cell was situated beneath the liquid level in the dish. The dish with the cell was placed in a dessicator, which was evacuated to 0.05 mbar and then carefully aerated with nitrogen. During the aeration, the electrochromic solution rose into the cell and filled the entire volume apart from a small bubble. The cell was removed from the solution, cleaned at the opening (6) under a nitrogen atmosphere by wiping with a paper towel and sealed with the photocuring epoxy adhesive DELO-Katiobond® 4594, DELO Industrieklebstoffe, Landsberg, thickened with 2% of silica gel aerosil. Finally, the cell was exposed to daylight in the vicinity of a window for 10 minutes and cured overnight at room temperature.

### Example 3

### (Comparative Example)

A cell was constructed as described in Example 2 except that a solution was used which contained, instead of the electrochromic compound of the formula

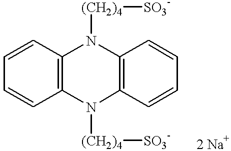

the electrochromic compound of the formula

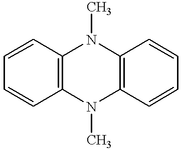

(likewise 0.02 molar).

### Comparison of the Cells of Examples 2 and 3

Both cells were slight yellowish in the unswitched state.

In both cases, application of a voltage of 1.2 V to the two rectangular ITO strips (2) and (5) of the cell of FIG. 1 resulted in a bluish green strip having sharp edges. The parts of the cell outside this strip remained uncolored. Disconnecting and short-circuiting the strips (2) and (5) resulted in immediate erasure of the color.

However, prolonged operation (20 min and 2 h) of the cells at 1.2 V showed differences between the two cells:

### Cell of Example 2

After 20 min and 2 h of operation, the bluish green strip still had sharp edges, and the cell parts outside the strip remained uncolored. After disconnecting from the voltage and short-circuiting, the color of the strip faded after 20 s.

### Cell of Example 3

After only 20 min of operation, a greenish yellow zone appeared on both sides of the bluish green strip. After 2 h of operation, the entire part of the cell outside the strip was greenish yellow. The strip itself was now greenish blue. After disconnecting from the voltage and short-circuiting, complete fading of the color of the strip took 5 min after 20 min of operation and 15 min after 2 h of operation.

Consequently, only the cell 2 according to the invention shows, even after prolonged operation, an image of the switched segment having sharp edges and rapid erasure after switching off the current and short-circuiting.

### Example 4

A cell was constructed entirely analogously to Example 2 which contained a solution which was 0.002 molar with respect to the electrochromic compound of the formula

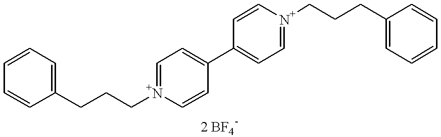

and 0.002 molar with respect to the electrochromic compound of the formula

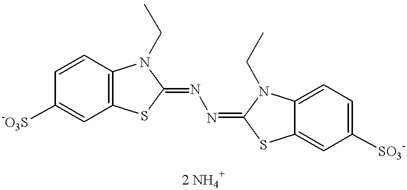

in anhydrous, oxygen-free N-methylpryrrolidone.

### Example 5

### (Comparative Example)

A cell was constructed entirely analogously to Example 2 except that it was 0.002 molar with respect to the electrochromic compound of the formula

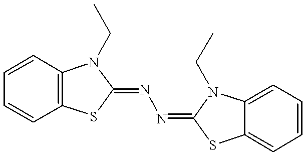

instead of the electrochromic compound of the formula

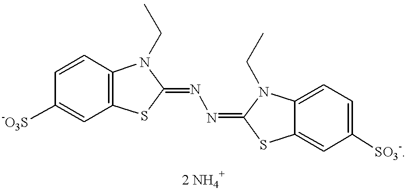

### Comparison of the Cells of Examples 4 and 5

Both cells were slightly yellowish in the unswitched state. In both cases, application of a voltage of 1.4 V to the two rectangular ITO strips (2) and (5) of the cell of FIG. 1 resulted in a blue strip having sharp edges. The parts of the cell outside this strip remained uncolored. Disconnecting and short-circuiting the strips (2) and (5) resulted in immediate erasure of the color.

However, prolonged operation (20 min and 2 h) of the cells at 1.4 V showed differences between the two cells:

### Cell of Example 4

After 20 min and 2 h of operation, the blue strip still had sharp edges, and the cell parts outside the strip remained uncolored. After disconnecting from the voltage and short-circuiting, the color of the strip faded after 20 s.

### Cell of Example 5

After only 20 min of operation, a slightly greenish yellow zone appeared on both sides of the blue strip. After 2 h of operation, the entire part of the cell outside the strip was slightly greenish yellow. After disconnecting from the voltage and short-circuiting, complete fading of the color of the strip took 5 min after 20 min of operation and 15 min after 2 h of operation.

Consequently, only the cell 4 according to the invention shows, even after prolonged operation, an image of the switched segment having sharp edges and rapid erasure after switching off the current and short-circuiting.

Although the present invention has been described in detail with reference to certain preferred versions thereof, other variations are possible. Therefore, the spirit and scope of the appended claims should not be limited to the description of the versions contained therein.

What is claimed is:

1. An electrochromic device comprising:
(a) a pair of glass or plastic plates or plastic films, wherein (i) at least one plate or film has one side with an electrically conductive coating, (ii) at least one plate or film and its conductive coating is trans-parent, (iii) a plate a film that is optionally mirrored, and (iv) at least one plate or film has an electrically conductive layer that is optionally divisible into separate, individually contacted area segments,
(b) a sealing ring that joins the plates or films together on the side of the conductive coating, and
(c) an electrochromic medium that fills volume formed by the a pair of glass or plastic plates or plastic films,
wherein the electrochromic medium comprises a pair of electrochromic substances OX₂ⁿ⁺ and RED₁^{m-}, in which n and m, independently of one another, are integers from 2 to 4.

2. The electrochromic device according to claim 1, wherein at least one electrically conductive layer is divided into separate, individually contacted area segments.

3. The electrochromic device according to claim 1, wherein n and m are 2.

4. The electrochromic device according to claim 1, wherein the electrochromic substances of the formula OX₂ⁿ⁺ are of the formulae 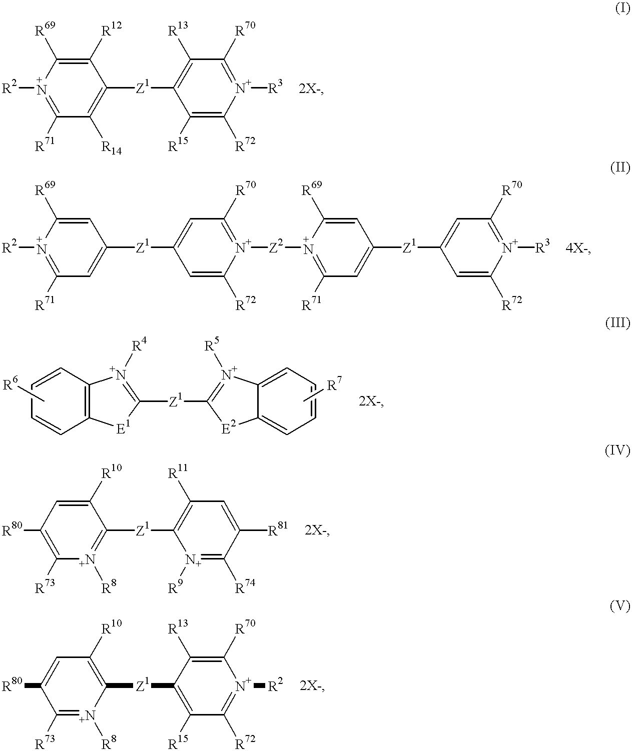
in which
R² to R⁵, R⁸ and R⁹, independently of one another, are C₁- to C₁₈-alkyl, C₂- to C₁₂-alkenyl, C₄- to C₇-cycloalkyl, C₇- to C₁₅-aralkyl or C₆- to C₁₀-aryl, or
R⁴; R or R⁸; R⁹ together can form a —(CH₂)₂— or —(CH₂)₃— bridge,
R⁶ and R⁷, independently of one another, are hydrogen, C₁- to C₄-alkyl, C₁- to C₄-alkoxy, halogen, cyano, nitro or C₁- to C₄-alkoxycarbonyl,
R¹⁰; R¹¹, R¹⁰; R¹³, R¹²; R¹³ and R¹⁴; R¹⁵, independently of one another, are hydrogen or in pairs are a —(CH₂)₂—, —(CH₂)₃— or —CH═CH— bridge,
R⁶⁹ to R⁷⁴, R⁸⁰ and R⁸¹, independently of one another, are hydrogen or C₁- to C₆-alkyl, and
R⁶⁹ to R⁷⁴, independently of one another, are additionally aryl, or
R⁶⁹; R¹², R⁷⁰; R¹³, R⁷³; R⁸⁰ and/or R⁷⁴; R⁸¹ together form a —CH═CH—CH═CH— bridge,
E¹ and E², independently of one another, are O, S, NR¹ or C(CH₃)₂, or
E¹ and E² together form an —N—(CH₂)₂—N— bridge,
R¹ is C₁- to C₁₈-alkyl, C₂- to C₁₂-alkenyl, C₄- to C₇-cycloalkyl, C₇- to C₁₅-aralkyl or C₆- to C₁₀-aryl,
Z¹ is a direct bond, —CH═CH—, —C(CH₃)═CH—, —C(CN)═CH—, —CCl═CCl—, —C(OH)═CH—, —CCl═CH—, —C—C—, —CH═N—N═CH—, —C(CH₃)═N—N═C(CH₃)—, —CCl═N—N═CCl— or —C₆H₄—,
Z² is —(CH₂)ᵣ— or —CH₂—C₆H₄—CH₂—,
r is an integer from 1 to 10, and
X⁻ is an anion which is redox-inert under the conditions.

5. The electrochromic device according to claim 1, wherein the electrochromic substances of the formula RED₁^{m-} used are of the formulae 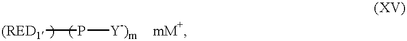
wherein
RED_{1′} is the m-valent radical of a reversibly oxidizable electrochromic compound,
P is a bridge,
Y⁻ is an anionic group,
M⁺ is a cation, and
m is an integer from 2 to 4.

6. The electrochromic device according to claim 5, wherein
P is a direct bond, —(CH₂)ₚ— or —C₆H₄—,
p is an integer from 1 to 12,
Y⁻ is SO₃⁻, OSO₃⁻, COO⁻, PO₃⁻, OPO₂⁻ or a radical of the formula [chemical structure]
or a mesomeric form thereof,
in which
Z is a bridge,
wherein
R¹⁰¹ to R¹⁰⁴, independently of one another, are alkyl or aryl, and
M⁺ is an ion of an alkali metal, an ammonium ion or one equivalent of OX₂^{m+}.

7. The electrochromic device according to claim 5, wherein RED_{1′} is a radical of the formulae 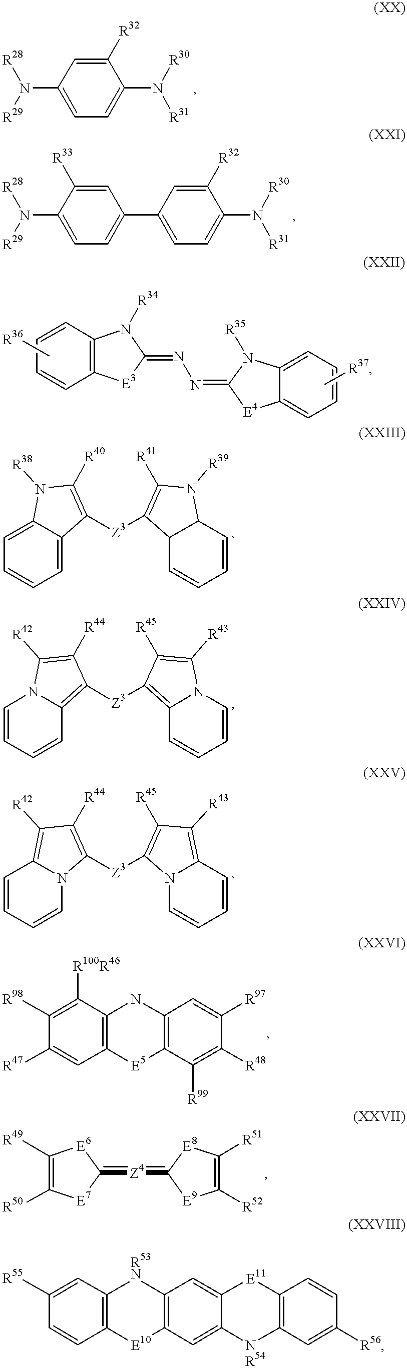
or ferrocene,
in which R²⁸ to R³¹, R³⁴, R³⁵, R³⁸, R³⁹, R⁴⁶, R⁵³ and R⁵⁴, independently of one another, are C₁- to C₁₈-alkyl, C₂- to C₁₂-alkenyl, C₄- to C₇-cycloalkyl, C₇- to C₁₅-aralkyl or C₆- to C₁₀-aryl,
R³², R³³, R³⁶, R³⁷, R⁴⁰, R⁴¹, R⁴² to R⁴⁵, R⁴⁷, R⁴⁸, R⁴⁹ to R⁵², R⁵⁵ to R⁵⁸ and R⁹⁷ to R¹⁰⁰, independently of one another, are hydrogen, C₁- to C₄-alkyl, C₁- to C₄-alkoxy, halogen, cyano, nitro, C₁- to C₄-alkoxycarbonyl, C₆- to C₁₀-aryl or C₆- to C₁₀-aryloxy, and
R⁵⁷ and R⁵⁸ are additionally an aromatic or quasi-aromatic, five- or six-membered heterocyclic ring which is optionally benzo-fused, and R⁴⁸ is additionally NR⁷⁵R⁷⁶, or
R⁴⁹; R⁵⁰, R⁵¹; R⁵² and/or R⁴⁸; R⁹⁷ or R⁴⁸; R⁹⁹, R⁹⁷; R⁹⁸ or R⁹⁸; R¹⁰⁰, independently of one another, form a —(CH₂)₃—, —(CH₂)₄—, —(CH₂)₅— or —CH═CH—CH═CH— bridge,
Z³ is a direct bond, a —CH═CH— or —N═N— bridge,
Z⁴ is a direct double bond, a ═CH—CH═ or ═N—N═ bridge,
E³ to E⁵, E¹⁰ and E¹¹, independently of one another, are O, S, NR⁵⁹ or C(CH₃)₂, and
E⁵ is additionally C═O or SO₂,
E³ and E⁴, independently of one another, can additionally be —CH═CH—,
E⁶ to E⁹, independently of one another, are S, Se or NR⁵⁹,
R⁵⁹, R⁷⁵ and R⁷⁶, independently of one another, are C₁- to C₁₂-alkyl, C₂- to C₈-alkenyl, C₄- to C₇-cycloalkyl, C₇- to C₁₅-aralkyl, C₆- to C₁₀-aryl, and
R⁷⁵ is additionally hydrogen or R⁷⁵ and R⁷⁶ in the definition of NR⁷⁵R⁷⁶ are, together with the N atom to which they are attached, a five- or six-membered ring, which optionally contains further heteroatoms,
R⁶¹ to R⁶⁸, independently of one another, are hydrogen, C₁- to C₆-alkyl, C₁- to C₄-alkoxy, cyano, C₁- to C₄-alkoxycarbonyl or C₆- to C₁₀-aryl, and
R⁶¹; R⁶² and R⁶⁷; R⁶⁸, independently of one another, additionally form a —(CH₂)₃—, —(CH₂)₄— or —CH═CH—CH═CH— bridge, or
R⁶²; R⁶³, R⁶⁴; R⁶⁵ and R⁶⁶; R⁶⁷ form an —O—CH₂CH₂—O— or —O—CH₂CH₂CH₂—O— bridge,
v is an integer between 0 and 100,
R⁸², R⁸³, R⁸⁸ and R⁸⁹, independently of one another, are C₁- to C₁₈-alkyl, C₂- to C₁₂-alkenyl, C₄- to C₇-cycloalkyl, C₇- to C₁₅-aralkyl or C₆- to C₁₀-aryl,
R⁵⁴ to R⁸⁷ and R⁹⁰ to R⁹³, independently of one another, are hydrogen or C₁- to C₆-alkyl, or
R⁸⁴; R⁸⁶, R⁸⁵; R⁸⁷, R⁹⁰; R⁹² and/or R⁹¹; R⁹³ together form a —CH═CH—CH═CH— bridge, and all radicals can additionally be a direct bond to P.

8. The electrochromic device according to claim 1, wherein the electrochromic medium contains an electrochromic substance of the formula OX₂²⁺ RED₁²⁻.

9. An electrochromic substance of the formula 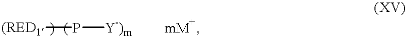
in which
RED_{1′} is the m-valent radical of a reversibly oxidizable electrochromic compound,
P is a bridge,
Y⁻ is an anionic group,
M⁺ is a cation, and
m is an integer from 2 to 4,
and the compounds of the formulae 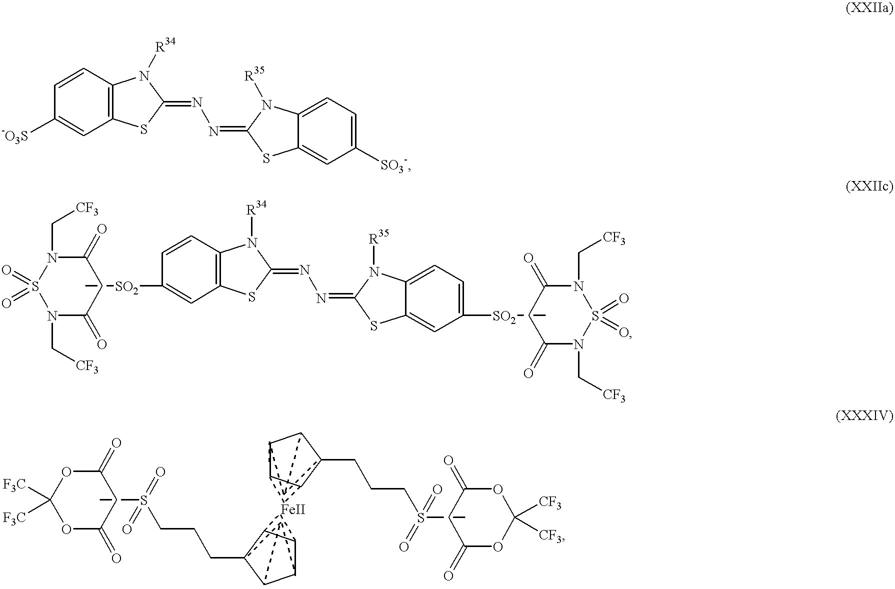
in which R³⁴ and R³⁵ are ethyl, are excluded.

10. An electrochromic substance of the formula
OX₂ⁿ⁺ RED₁^{m-} (C),
wherein
RED_{1′} is the m-valent radical of a reversibly oxidizable electrochromic compound,
OX₂ⁿ⁺ are selected from the group of compounds having the formulae 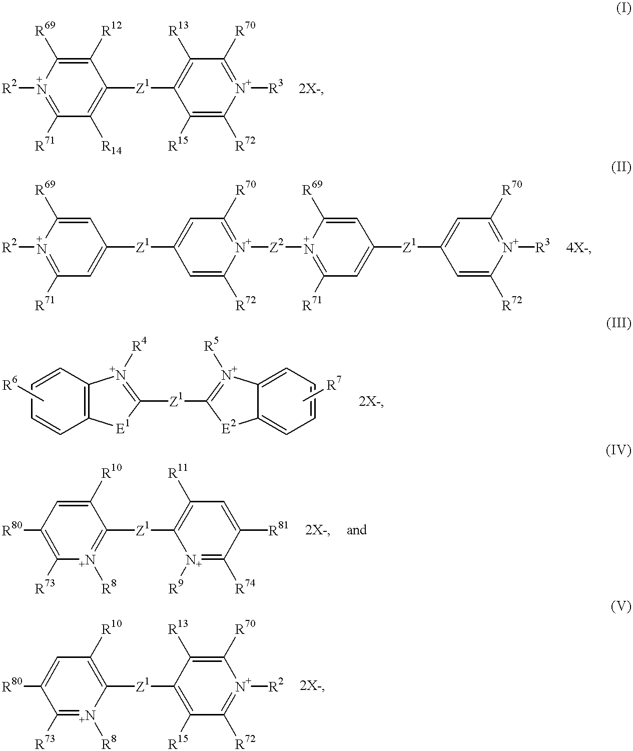
wherein R² to R⁵, R⁸ and R⁹, independently of one another, are C₁- to C₁₈-alkyl, C₂- to C₁₂-alkenyl, C₄- to C₇-cycloalkyl, C₇- to C₁₅-aralkyl or C₆- to C₁₀-aryl, or
R⁴; R⁵ or R⁸; R⁹ together can form a —(CH₂)₂— or —(CH₂)₃— bridge,
R⁶ and R⁷, independently of one another, are hydrogen, C₁- to C₄-alkyl, C₁- to C₄-alkoxy, halogen, cyano, nitro or C₁- to C₄-alkoxycarbonyl,
R¹⁰; R¹¹, R¹⁰; R¹³, R¹²; R¹³ and R¹⁴; R¹⁵, independently of one another, are hydrogen or in pairs are a —(CH₂)₂—, —(CH₂)₃— or —CH═CH— bridge,
R⁶⁹ to R⁷⁴, R⁸⁰ and R⁸¹, independently of one another, are hydrogen or C₁- to C₆-alkyl, and
R⁶⁹ to R⁷⁴, independently of one another, are additionally aryl, or
R⁶⁹; R¹², R⁷⁰; R¹³, R⁷³; R⁸⁰ and/or R⁷⁴; R⁸¹ together form a —CH═CH—CH═CH— bridge,
E¹ and E², independently of one another, are O, S, NR¹ or C(CH₃)₂, or
E¹ and E² together form an —N—(CH₂)₂—N— bridge,
R¹ is C₁- to C₁₈-alkyl, C₂- to C₁₂-alkenyl, C₄- to C₇-cycloalkyl, C₇- to C₁₅-aralkyl or C₆- to C₁₀-aryl,
Z¹ is a direct bond, —CH═CH—, —C(CH₃)═CH—, —C(CN)═CH—, —CCl═CCl—, —C(OH)═CH—, —CCl═CH—, —C═C—, —CH═N—N═CH—, —C(CH₃)═N—N═C(CH₃)—, —CCl═N—N═CCl— or —C₆H₄—,
Z² is —(CH₂)ᵣ— or —CH₂—C₆H₄—CH₂—,
r is an integer from 1 to 10, and
X⁻ is an anion which is redox-inert under the conditions, and
m and n are 2.
